(19) United States
(12) Patent Application Publication
(10) Pub. No.: US 2026/0361063 A1
(43) Pub. Date: Nov. 12, 2026

(54) UTILITY RECEIVER

(71) Applicant: 2721111 Ontario Inc., Vaughan (CA)

(72) Inventor: Paolo MANTENUTO, Vaughan (CA)

(21) Appl. No.: 19/127,908

(22) PCT Filed: Sep. 30, 2022
(86) PCT No.: PCT/CA2022/051454

§ 371 Date: May 7, 2025

(51) Int. Cl. H02G 3/12; F21S 8/02; F21V 21/04; H02G 3/08

(52) U.S. Cl. CPC H02G 3/123; F21S 8/026; F21V 21/046; H02G 3/081

(57) ABSTRACT

The present invention is a utility receiver pan having walls and a retaining lip for mounting into dry wall openings by using retaining arms to pinch dry wall against the retaining lip. In another embodiment the present invention is a utility receiver quadrilateral pan for nesting a circular utility to create an illusion of a rectangular prism utility receiver pan when in use.

### FIELD OF THE INVENTION

The present invention relates to utility receivers for mounting gas, battery, electric, and other utilities with easy installation, and for altering appearance from a generally circular shape to a non-circular shape.

### SUMMARY

The present invention is a utility receiver in the form of a pan having walls and a retaining lip, for mounting into drywall openings by using retaining arms to pinch drywall against the retaining lip.

In another embodiment, the present invention is a utility receiver in the form of a quadrilateral pan for nesting a circular utility to create an illusion of a rectangular-prism utility when in use.

### BACKGROUND

Home decoration fashion tastes continually change, and the desire to change fashionable decor is not problematic as long as there is no need for a change in functional installment of a new desired decor.

A change in home decor involving electrically connected utilities such as ceiling lights or thermostat boxes can be challenging however, because these utilities are typically subject to standardized mounts.

In the case of light bulbs for example, historically, light bulbs have been circular in shape and design because of the ease involved with blowing glass in a circular form.

Light bulbs are also blown into a circular shape because circular bulbs minimize any weakness point in their glass casing—this feature allows the bulb to withstand expansion and contraction (from the bulb heat) without cracking and breaking).

Additionally, circular lights have been advantageous because of the ease with which circular holes could be drilled into drywall (using a hole saw drill bit).

Moreover, standardized home ceiling decor involves circular lights that, even in the case of pot lights, are not mounted in a flush fashion—ie they do not offer a “minimalist” aesthetic by being co-planar with the surface into which they are mounted.

Also with circular lights, observers can not only visually determine that the light source is circular in shape, but circular shaped lights result in “distance-glare”—an inability to see the bulb detail itself because of its shape and visibility extending circularly outwardly from the ceiling (a limitation present even in pot lights).

Circular light bulbs result in object illumination while having a visible light source.

As light bulbs cannot be blown into a shape other than circular (a limitation of the glass blowing arts), there is presently no ability for people to decorate their homes using bulbs that are in a shape other than circular.

Even where it is desired to install lights offering a differing appearance (such as with fluorescent lights), complicated construction alterations are required (such as removing large pieces of drywall, removing existing electrical components, and installing differing electrical components to accommodate fluorescent bulbs in terms of shape, connection, and the like).

Presently there is no ability to offer an illusion of non-circular-shaped light bulbs without complicated removal and replacement of existing electrical infrastructure there is no simple, easy-to-mount retro-fit that can convert circular light bulbs to an illusion of non-circular light (thus also eliminating distance glare).

There is also no present solution for using circular light bulbs to illuminate objects without disclosing (or making visible) the light source.

Even with other circular utilities (apart from light bulbs), such as smart thermostats and fire alarms), there is presently no easy retro-fit solution for installing them into a wall or ceiling to give a non-circular recessed appearance that is also flush or co-planar with the wall or ceiling into which same is mounted.

### DRAWINGS

FIG. 1 is a first perspective view of a utility receiver.

FIG. 2 is a second perspective view of the utility receiver.

FIG. 3 is a plan view first side of the utility receiver.

FIG. 4 is a plan view second side of the utility receiver.

FIG. 5 is a plan top view of the utility receiver.

FIG. 6 is a plan bottom view of the utility receiver.

FIG. 7 is a cross section view along 7-7 of the utility receiver.

FIG. 8 is a perspective view of a mounting template to install the utility receiver.

FIG. 9 is a perspective view of the mounting template attached to a wall surface.

FIG. 10 is a perspective view of the mounting template removed from the wall surface

FIG. 11 is a perspective view of preparing the receiver for insertion into the wall surface.

FIG. 12 is a perspective view of the receiver insertion.

FIG. 13 is a perspective view of the receiver mounted within the wall surface.

FIG. 14 is a perspective see-through view of the receiver being secured to the wall surface.

FIG. 15 is a top plan view of the mounted receiver.

FIG. 16 is a cross section view along the line 16-16.

FIG. 17 is a perspective view of the mounted receiver with utility opening formed.

FIG. 18 is a perspective view of electric utility insertion into the mounted receiver.

FIG. 19 is a perspective view of electric utility insertion secured in the mounted receiver.

FIG. 20 is a top-side perspective view showing the electric utility secured in the mounted receiver

FIG. 21 is a top-side plan view showing the electric utility secured in the mounted receiver

FIG. 22 is a cross section view along the line 22-22

FIG. 23 is a first perspective view of an alternate embodiment having a perforated lip

FIG. 24 is a second perspective view of the alternate embodiment having the perforated lip

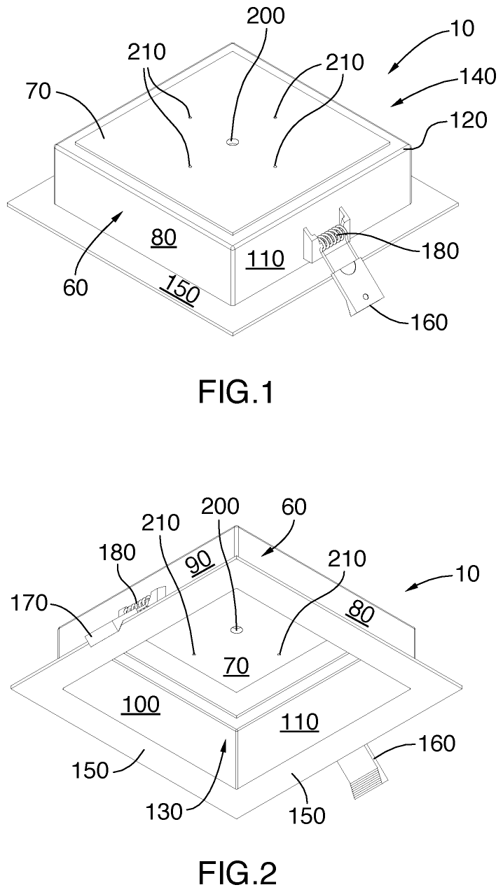

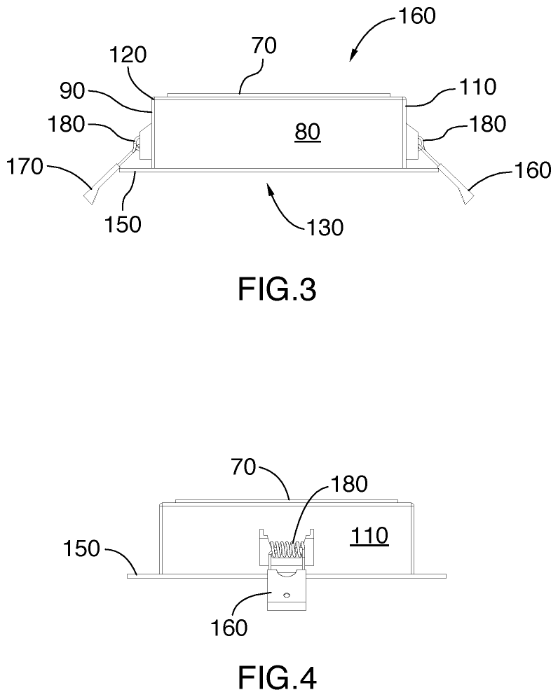

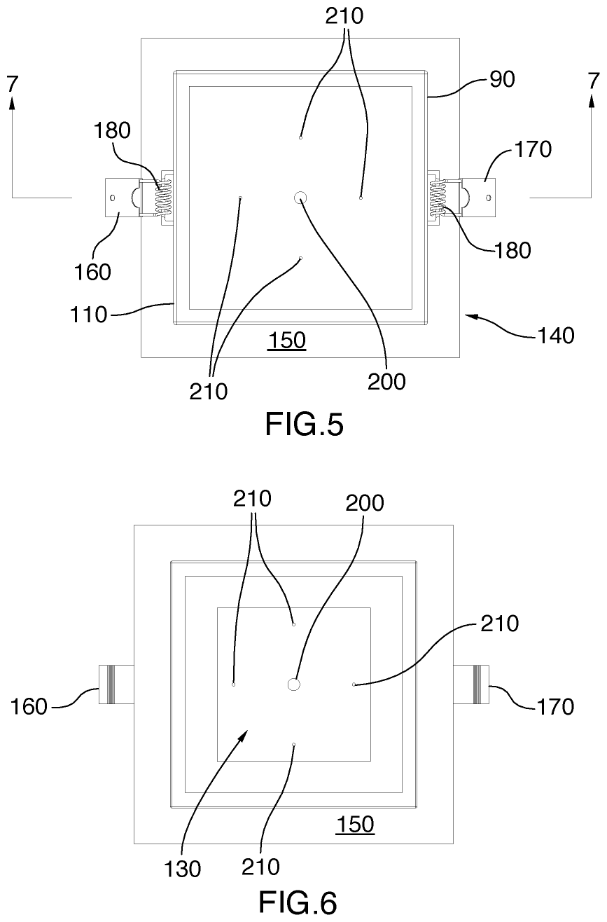

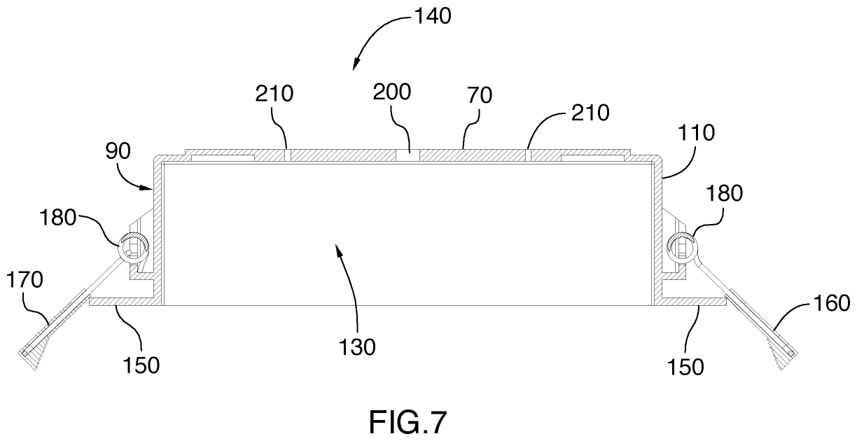

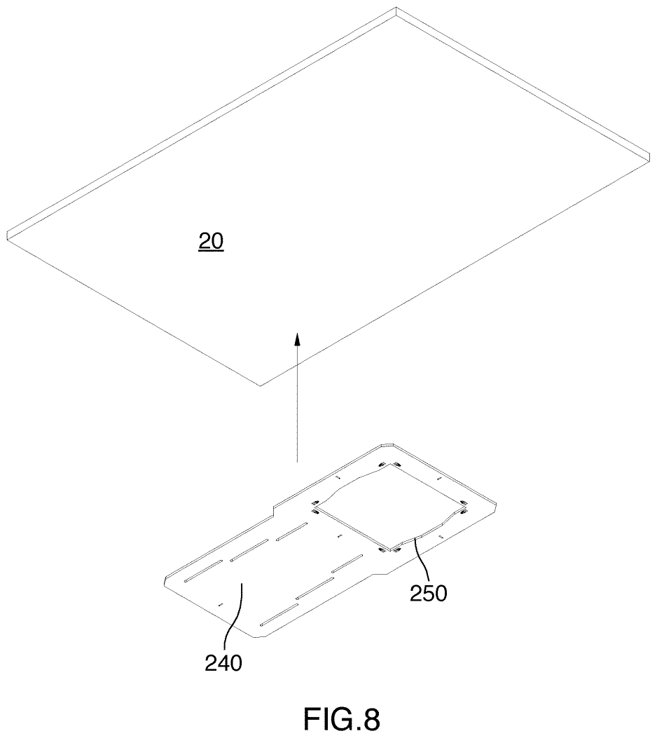

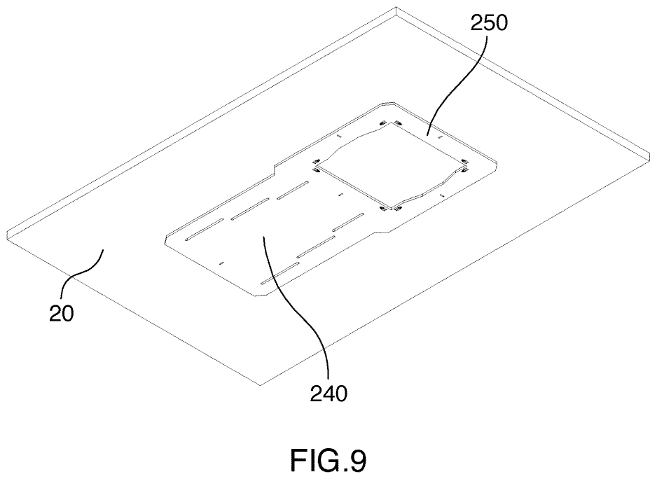

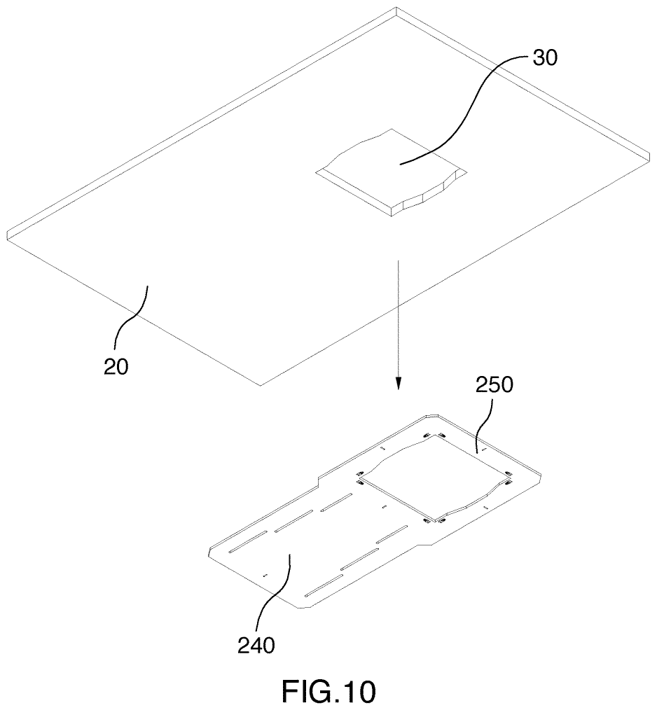

### DESCRIPTION

The present invention relates to a utility receiver (10) for mounting within an associated drywall (20) opening (30), the associated drywall (20) having a defined inside (40) and an outside (50).

Generally the invention comprises a quadrilateral shaped pan (60) having a horizontal base (70), four vertical walls (80, 90, 100, 110) connected to one another with each wall (80, 90, 100, 110) attached at one end (120) to the base (70) to define an inside (130) and an outside (140).

The base (70) and vertical walls (80, 90, 100, 110) are sized and shaped for passing through the drywall (20) opening (30) in a direction from the drywall (20) outside (50) toward drywall inside (40).

Moreover, a flanged outwardly extending horizontal retaining lip (150) circumscribes the walls (80, 90, 100, 110) and attaches at an end opposing the base (70).

The retaining lip (150) presses against the drywall (20) outside (50) when the base (70) and walls (80, 90, 100, 110) are disposed through the drywall (20) opening (30) toward the drywall (20) inside (40).

The retaining lip (150) is sized and shaped to prohibit passage through the drywall (20) opening (30).

There are also at least two retaining arms (160, 170), each hinged (180) to a respective opposing wall (80, 90, 100, 110) on the pan (60) outside(140).

Each arm (160, 170) is flexibly biased away from the base (70) and toward the retaining lip (150), and each arm (160, 170) extends from their respective wall (80, 90, 100, 110) and beyond the retaining lip (150).

The arms (160, 170) are movable between a position toward the retaining lip (150) and a position away from the retaining lip (150).

The movable nature of the arms (160, 170), combined with being biased away from the base (70), results in the arms (160, 170) pressing against the drywall (20) inside (40) when the pan (60) is mounted through the drywall (20) opening (30) toward the drywall (20) inside (40).

When installed, the drywall (20) is pinched between each arm (160, 170) and the retaining lip (150).

In an optional embodiment, the utility receiver (10) can have a retaining lip (150) with a series of perforations (190) to facilitate attachment to dry wall (20) with joint compound (not shown).

The perforated openings (190) help to create a “flatter” illusion when installed, making the receiver (10) appear co-planar with the surrounding wall.

Joint compound (not shown)—also known as drywall (20) mud—is typically a gypsum-based paste used to finish drywall (20) surfaces, joints, and corners in drywall (20) installations

To facilitate installation, the utility receiver (10) can also include a centrally defined pilot hole (200) for using a hole saw drill bit (not shown) therein.

The centrally defined pilot hole (200) is within the base (70), since a utility (electrical, gas, regulator, etc.) will more than likely need to create a significant opening (220).

Where it is desired to pass a utility such as a potlight (230) through the base (70), in using a hole saw drill bit (not shown), an installer can take advantage of an additional plurality of defined pilot holes (210) disposed around the central pilot hole (200) to facilitate drilling and punching through, in order to create a pan opening (220).

In use, the receiver (10) can be installed as follows, as an example of an easy either retrograde fit or fresh installation.

In an instance where there is no pre-existing drywall (20) opening (30), an opening (30) can be defined and cut using a template (240), by attaching the template (240) to the drywall (20) temporarily and cutting through the drywall (20) according to a cutting outline (250).

Once the opening (30) has been created, the template (240) can be detached from the drywall (20) and removed.

The template (240) is re-usable, and one single template (240) can be used for an unlimited number of installations.

At any time, but typically prior to inserting the receiver (10), a user may opt to drill through the central pilot hole (200) using a hole saw drill bit (not shown) to remove a portion of the base (70) thereby creating an opening (220) for any select utility to pass therethrough or settle therein.

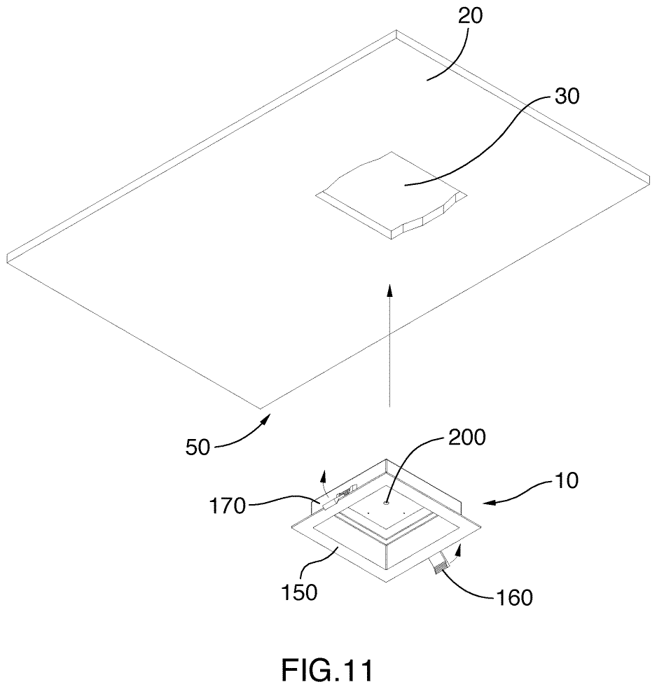

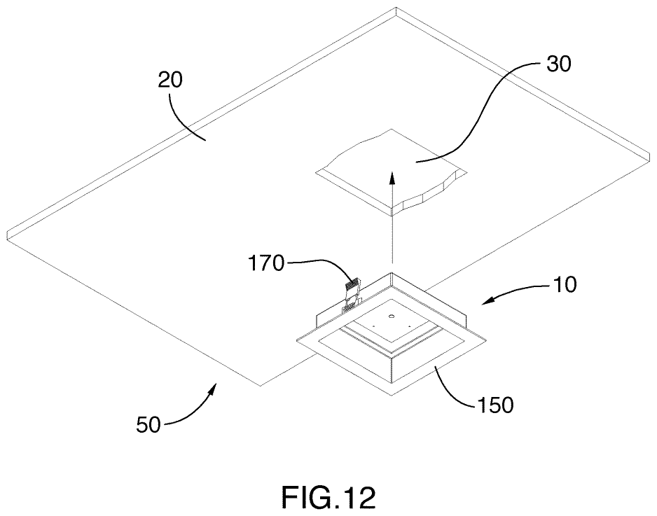

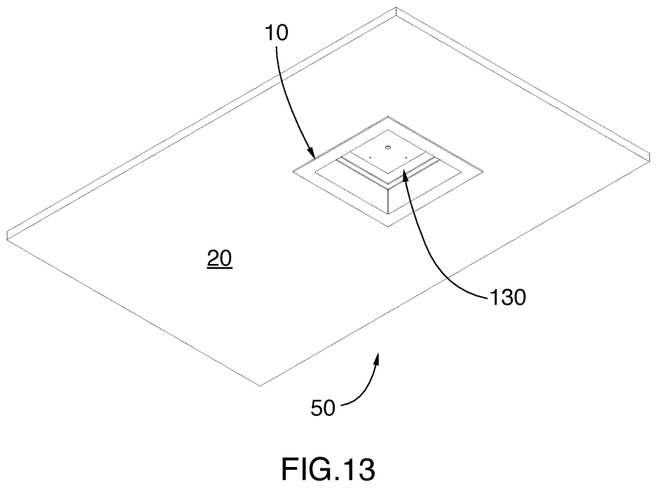

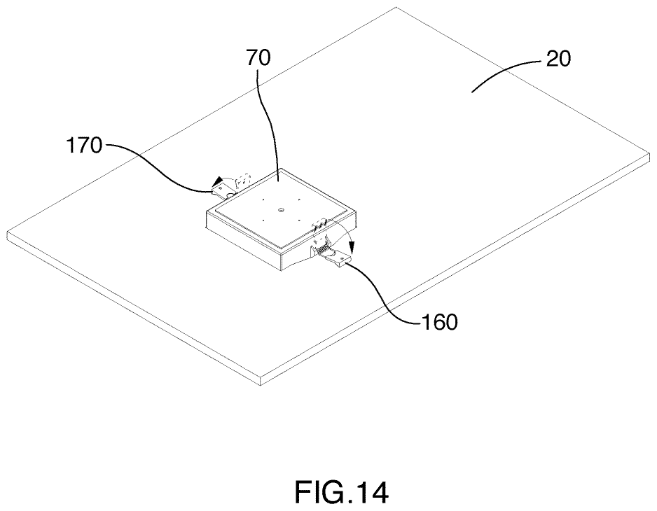

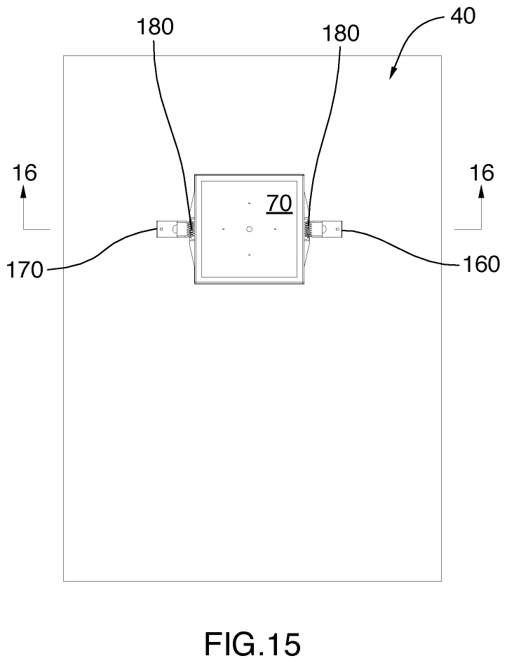

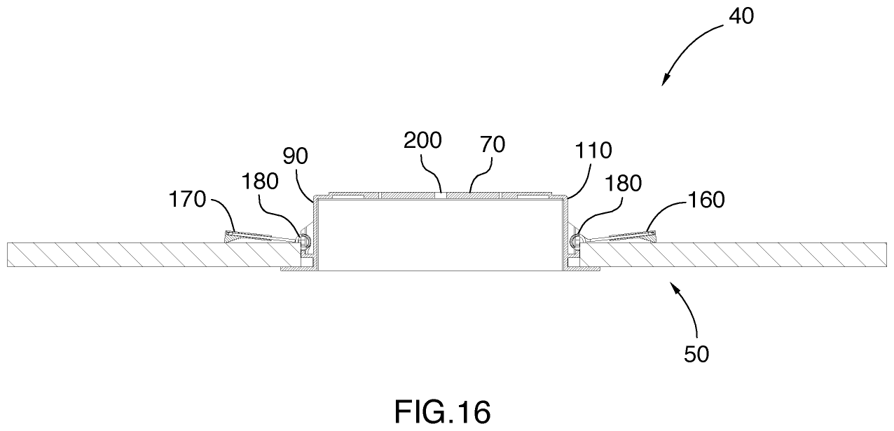

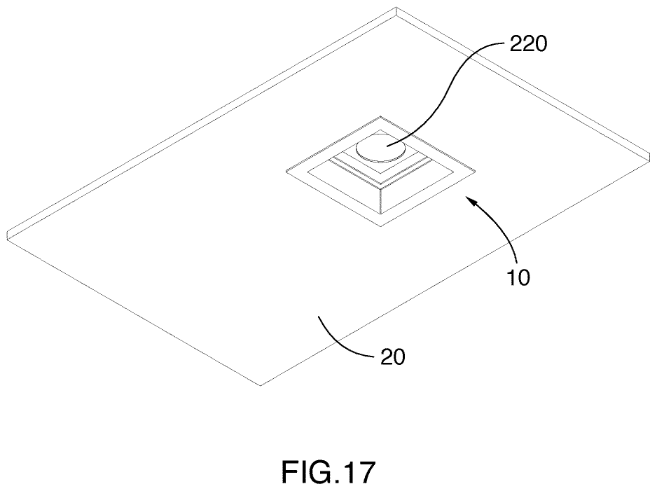

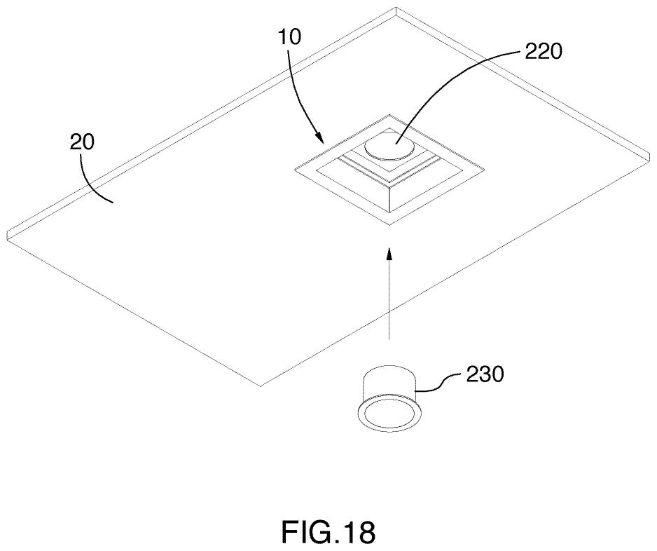

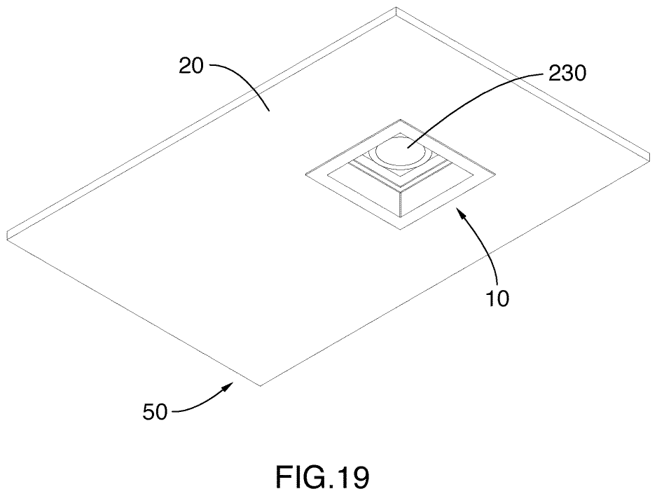

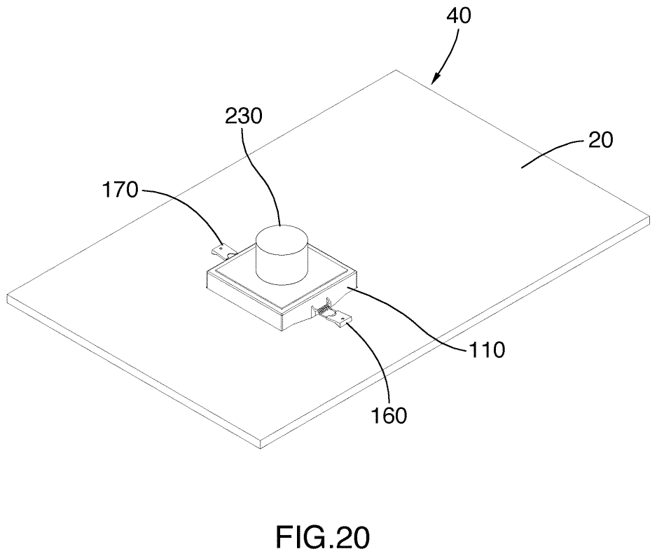

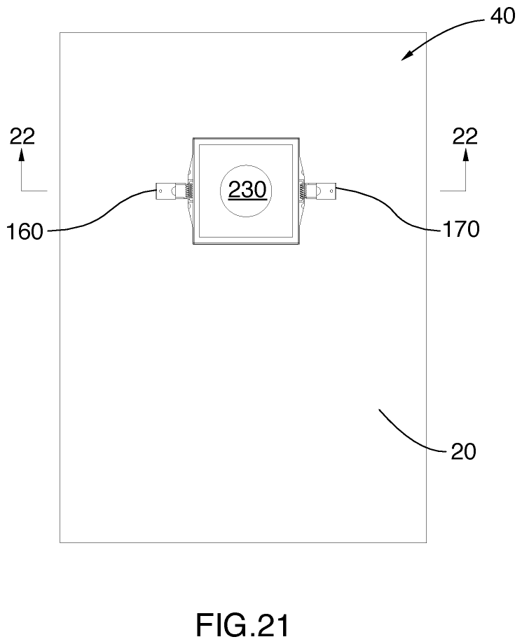

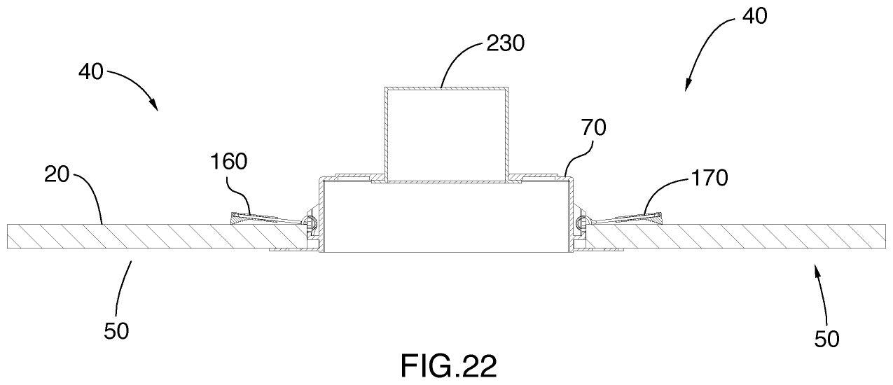

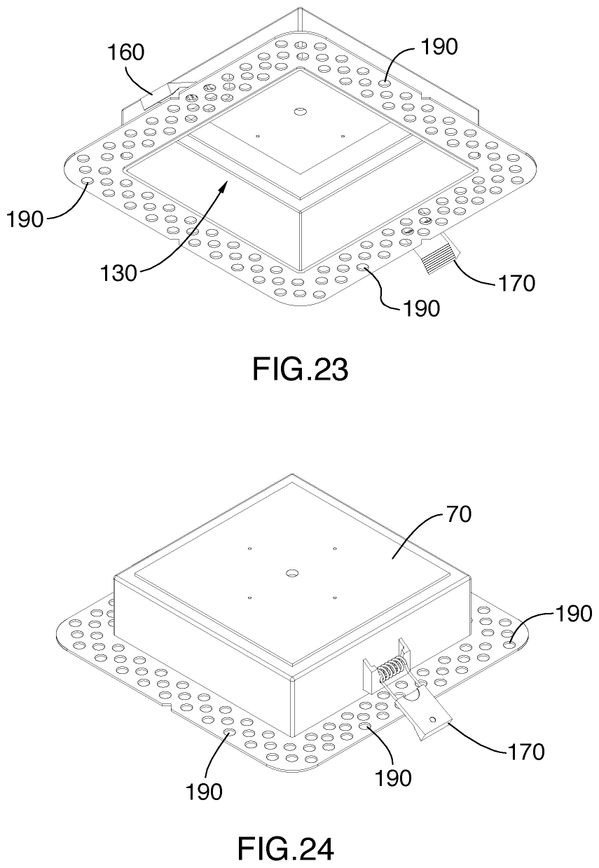

The receiver (10) is inserted into the drywall (20) opening (30) by biasing the retaining arms (160, 170) toward the base prior to insertion, and then sliding the receiver (10) into the opening (30), as shown in FIG. 11 through FIG. 16.

As soon as the retaining arms (160, 170) are released, they automatically spring back toward the retaining lip (150) thereby clamping onto the drywall (20) inside (40), with the drywall outside pressed against the retaining lip (150).

No additional action is required regarding inserting the receiver (10) into the opening (30).

At this point, a utility, such as a potlight (230) can be placed within the receiver (10) and through the pan opening (220), to be connected to an appropriate infrastructure system (such as electricity, battery, or gas).

In the instance where the utility is a (circular) potlight (230), the light will, at a set distance away, appear rectangular-prism in nature, when otherwise the light would have projected in a circular fashion when in use.

What is claimed is:

1. A utility receiver for mounting within an associated drywall opening, the associated drywall having a defined inside and an outside, comprising:
a quadrilateral shaped pan having a horizontal base, four vertical walls connected to one another with each wall attached at one end to the base to define an inside and an outside, the base and vertical walls being sized and shaped for passing through the drywall opening in a direction from the drywall outside toward drywall inside;
a flanged outwardly extending horizontal retaining lip circumscribing the walls and attached at an end opposing the base, for pressing against the drywall outside when the base and walls are disposed through the drywall opening toward the drywall inside, the retaining lip being sized and shaped to prohibit passage through the drywall opening; and
at least two retaining arms, each arm hinged to a respective opposing wall on the pan outside, each arm flexibly biased away from the base and toward the retaining lip, each arm extending from their respective wall and beyond the retaining lip, with each arm being movable between a position toward the retaining lip and a position away from the retaining lip, for pressing against the drywall inside when the pan is mounted through the drywall opening toward the drywall inside, the drywall being pinched between each arm and the retaining lip.

2. The utility receiver in claim 1 wherein the retaining lip is perforated to facilitate attachment to dry wall with joint compound.

3. The utility receiver in claim 1 further comprising a centrally defined pilot hole for using a hole saw drill bit therein.

4. The utility receiver in claim 1 further comprising a plurality of defined pilot holes for receiving fasteners therethrough.
